(19) United States
(12) Patent Application Publication
(10) Pub. No.: US 2021/0355745 A1
(43) Pub. Date: Nov. 18, 2021

(54) SLIDABLE PANEL FRAME ASSEMBLY HAVING THERMAL BREAKS AND METHOD THEREFOR

(71) Applicant: EYAL SHOSHAN, LAS VEGAS, NV (US)

(72) Inventor: EYAL SHOSHAN, LAS VEGAS, NV (US)

(21) Appl. No.: 15/930,191

(22) Filed: May 12, 2020

(51) Int. Cl. E06B 3/263

(52) U.S. Cl. CPC E06B 3/26305; E06B 2003/26379; E06B 2003/26312

(57) ABSTRACT

A thermally-broken slidable panel frame assembly formed from a plurality of aluminum profile assemblies. The aluminum profile assemblies can include different shaped aluminum profiles that can be coupled together with thermal break strips. The aluminum profile assemblies, in turn, can be snap fitted together to form a complete frame assembly that can support slidable panels. The frame assembly can be integrated with other components to form a slidable panel system for sliding doors or windows or other slidable panels. The frame assembly is assembled from multiple individual components, providing for ease in setup and installation compared to previous implementations.

### TECHNICAL FIELD

The present disclosure generally relates to sliding door or window systems and, more particularly, to a thermally-broken slidable panel frame assembly formed from a plurality of aluminum profile assemblies that can be snap fitted together to form a complete frame.

### BACKGROUND

Aluminum profiles, manufactured from extruded aluminum, are commonly used in the construction industry. One particular way in which aluminum profiles are frequently utilized is to form frames, tracks, rails, mullions, and the like in building fenestration systems, including sliding door and window systems. A trend in modern construction involves the use of multi-panel sliding door and window systems. Such systems typically utilize frames formed of aluminum profiles. Multi-panel sliding door and window systems can be positioned in relatively large fenestrations in building structures, maximizing natural light and providing vast and unobstructed views to the outdoors, unlike typical traditional sliding door and window systems of the past. Multi-panel sliding door and window systems can utilize a plurality of slidable panels to suit various needs and preferences. For example, it is not uncommon for modern multi-panel sliding door and window systems to include configurations having up to eight or more slidable panels.

Typically, the slidable panels in multi-panel sliding door and window systems are positioned in parallel with one another, with one to two slidable panels utilizing a given track. When the doors or windows are open, the slidable panels can be stored side-by-side, in a stacked arrangement with one another. In various typical configurations, the slidable panels can be stored on one side of the fenestration, on both sides of the fenestration, or in wall pockets on either or both sides of the fenestration. When the doors or windows are closed, the slidable panels are typically positioned end-to-end, in an interlocking arrangement with one another.

Another trend in modern construction involves the use of sustainable building practices and energy-efficient design. With respect to door and window systems, one way to provide increased energy efficiency is through the use of thermal break strips, which help to prevent thermal energy loss. The thermal break strips are typically positioned between framing members, providing an insulating barrier between the building interior and building exterior.

A problem that arises with modern multi-panel sliding door and window systems is that they require frame assemblies having relatively greater dimensions compared to traditional sliding door and window systems, in order to accommodate an increased number of slidable panels. Since one to two panels can utilize a given track, as the number of panels increases, the dimensions of the frame also increases, to accommodate multiple panels and tracks. For example, depending on the number and size of the slidable panels utilized in a given system, multi-panel sliding door and window systems can require frames having head, sill, and jamb depths of roughly fourteen inches or more, and can have overall widths of up to roughly fifty feet or more. Building frames of such dimensions can be cumbersome, time-consuming, and expensive. Further, it is often desirable for each slidable panel to operate within an insulated portion of the frame for increased energy efficiency. Due to the increased number of slidable panels and enlarged frame dimensions in modern multi-panel sliding door and window systems, making energy-efficient frames can be can be cumbersome, time-consuming, and expensive.

The present disclosure relates to a thermally-broken slidable panel frame assembly for sliding closure systems such as doors or windows which is formed from a plurality of aluminum profile assemblies that can be snap fitted together to form a complete frame. It addresses problems encountered in previous profile and frame assemblies as well as provides other, related advantages.

### SUMMARY OF THE INVENTION

In accordance with one embodiment of the present invention, a slidable panel frame assembly is disclosed. The slidable panel frame assembly comprises, in combination: a plurality of aluminum profile assemblies, including at least a first aluminum profile assembly and a second aluminum profile assembly, wherein the first aluminum profile assembly comprises: an end aluminum profile; an intermediate aluminum profile spaced apart from the end aluminum profile, wherein the intermediate aluminum profile has first and second receiving members; and at least one thermal break strip juxtaposed between the end aluminum profile and the intermediate aluminum profile, wherein the at least one thermal break strip is configured to be coupled to the end aluminum profile and the intermediate aluminum profile so that the end aluminum profile and the intermediate aluminum profile can be coupled together, wherein the second aluminum profile assembly comprises: a connecting aluminum profile, wherein the connecting aluminum profile has first and second coupling members; an end aluminum profile spaced apart from the connecting aluminum profile; and at least one thermal break strip juxtaposed between the connecting aluminum profile and the end aluminum profile, wherein the at least one thermal break strip is configured to be coupled to the connecting aluminum profile and the end aluminum profile so that the connecting aluminum profile and the end aluminum profile can be coupled together; wherein the first and second coupling members of the second aluminum profile assembly are configured to form a snap-fit engagement with the first and second receiving members of the first aluminum profile assembly so that the plurality of aluminum profile assemblies can be coupled together; and a plurality of channels defined by the plurality of aluminum profile assemblies, wherein each channel is configured to receive a portion of at least one slidable panel.

In accordance with another embodiment of the present invention, a slidable panel frame assembly is disclosed. The slidable panel frame assembly comprises, in combination: a plurality of aluminum profile assemblies, including at least a first aluminum profile assembly, a second aluminum profile assembly, a third aluminum profile assembly, and a fourth aluminum profile assembly; wherein the first aluminum profile assembly comprises: an end aluminum profile; an intermediate aluminum profile spaced apart from the end aluminum profile, wherein the intermediate aluminum profile has first and second receiving members; and at least one thermal break strip juxtaposed between the end aluminum profile and the intermediate aluminum profile, wherein the at least one thermal break strip is configured to be coupled to the end aluminum profile and the intermediate aluminum profile so that the end aluminum profile and the intermediate aluminum profile can be coupled together, wherein the second aluminum profile assembly comprises: a connecting aluminum profile, wherein the connecting aluminum profile has first and second coupling members; an end aluminum profile spaced apart from the connecting aluminum profile; and at least one thermal break strip juxtaposed between the connecting aluminum profile and the end aluminum profile, wherein the at least one thermal break strip is configured to be coupled to the connecting aluminum profile and the end aluminum profile so that the connecting aluminum profile and the end aluminum profile can be coupled together; wherein the third aluminum profile assembly comprises: a connecting aluminum profile, wherein the connecting aluminum profile has first and second coupling members; an intermediate aluminum profile spaced apart from the connecting aluminum profile, wherein the intermediate aluminum profile has first and second receiving members; and at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together; and wherein the fourth aluminum profile assembly comprises: a connecting aluminum profile, wherein the connecting aluminum profile has first and second coupling members; an intermediate aluminum profile spaced apart from the connecting aluminum profile, wherein the intermediate aluminum profile has first and second receiving members; and at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together, wherein the first and second coupling members of the third aluminum profile assembly are configured to form a snap-fit engagement with the first and second receiving members of the first aluminum profile assembly; and wherein the first and second coupling members of the fourth aluminum profile assembly are configured to form a snap-fit engagement with the first and second receiving members of the third aluminum profile assembly; and wherein the first and second coupling members of the second aluminum profile assembly are configured to form a snap-fit engagement with the first and second receiving members of the fourth aluminum profile assembly so that the plurality of aluminum profile assemblies can be coupled together, and a plurality of channels defined by the plurality of aluminum profile assemblies, wherein each channel is configured to receive a portion of at least one slidable panel.

In accordance with another embodiment of the present invention, a slidable panel system is disclosed. The slidable panel system comprises, in combination: a plurality of slidable panels; a plurality of aluminum profile assemblies, including at least a first aluminum profile assembly, a second aluminum profile assembly, a third aluminum profile assembly, and a fourth aluminum profile assembly, wherein the first aluminum profile assembly comprises: an end aluminum profile; an intermediate aluminum profile spaced apart from the end aluminum profile, wherein the intermediate aluminum profile has first and second receiving members; and at least one thermal break strip juxtaposed between the end aluminum profile and the intermediate aluminum profile, wherein the at least one thermal break strip is configured to be coupled to the end aluminum profile and the intermediate aluminum profile so that the end aluminum profile and the intermediate aluminum profile can be coupled together; wherein the second aluminum profile assembly comprises: a connecting aluminum profile, wherein the connecting aluminum profile has first and second coupling members; an end aluminum profile spaced apart from the connecting aluminum profile; and at least one thermal break strip juxtaposed between the connecting aluminum profile and the end aluminum profile, wherein the at least one thermal break strip is configured to be coupled to the connecting aluminum profile and the end aluminum profile so that the connecting aluminum profile and the end aluminum profile can be coupled together; wherein the third aluminum profile assembly comprises: a connecting aluminum profile, wherein the connecting aluminum profile has first and second coupling members; an intermediate aluminum profile spaced apart from the connecting aluminum profile, wherein the intermediate aluminum profile has first and second receiving members; and at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together, and wherein the fourth aluminum profile assembly comprises: a connecting aluminum profile, wherein the connecting aluminum profile has first and second coupling members; an intermediate aluminum profile spaced apart from the connecting aluminum profile, wherein the intermediate aluminum profile has first and second receiving members; and at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together, wherein the first and second coupling members of the third aluminum profile assembly are configured to form a snap-fit engagement with the first and second receiving members of the first aluminum profile assembly, and wherein the first and second coupling members of the fourth aluminum profile assembly are configured to form a snap-fit engagement with the first and second receiving members of the third aluminum profile assembly; and wherein the first and second coupling members of the second aluminum profile assembly are configured to form a snap-fit engagement with the first and second receiving members of the fourth aluminum profile assembly so that the plurality of aluminum profile assemblies can be coupled together, and a plurality of channels defined by the plurality of aluminum profile assemblies, wherein each channel is configured to receive a portion of at least one of the plurality of slidable panels.

### BRIEF DESCRIPTION OF DRAWINGS

The present application is further detailed with respect to the following drawings. These figures are not intended to limit the scope of the present application, but rather, illustrate certain attributes thereof. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use and further objectives and advantages thereof can be best understood by reference to the following detailed description of illustrative embodiments when read in conjunction with the accompanying drawings, wherein:

FIG. 1 is an end view of an exemplary aluminum profile in accordance with one aspect of the present disclosure;

FIG. 2 is an end view of an exemplary aluminum profile in accordance with one aspect of the present disclosure;

FIG. 3 is an end view of an exemplary aluminum profile in accordance with one aspect of the present disclosure;

FIG. 4 is an and view of an exemplary aluminum profile assembly in accordance with one aspect of the present disclosure;

FIG. 5 is an end view of an exemplary aluminum profile assembly in accordance with one aspect of the present disclosure;

FIG. 6 is an end view of an exemplary aluminum profile assembly in accordance with one aspect of the present disclosure;

FIG. 7 is an and view of the aluminum profile assemblies of FIGS. 4 and 5, illustrating a manner of coupling thereof in accordance with one aspect of the present disclosure;

FIG. 8 is an end view of the aluminum profile assemblies of FIGS. 5 and 6, illustrating a manner of coupling thereof in accordance with one aspect of the present disclosure; and

FIG. 9 is an end view of an exemplary slidable panel system in accordance with one aspect of the present disclosure.

### DESCRIPTION OF THE DISCLOSURE

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

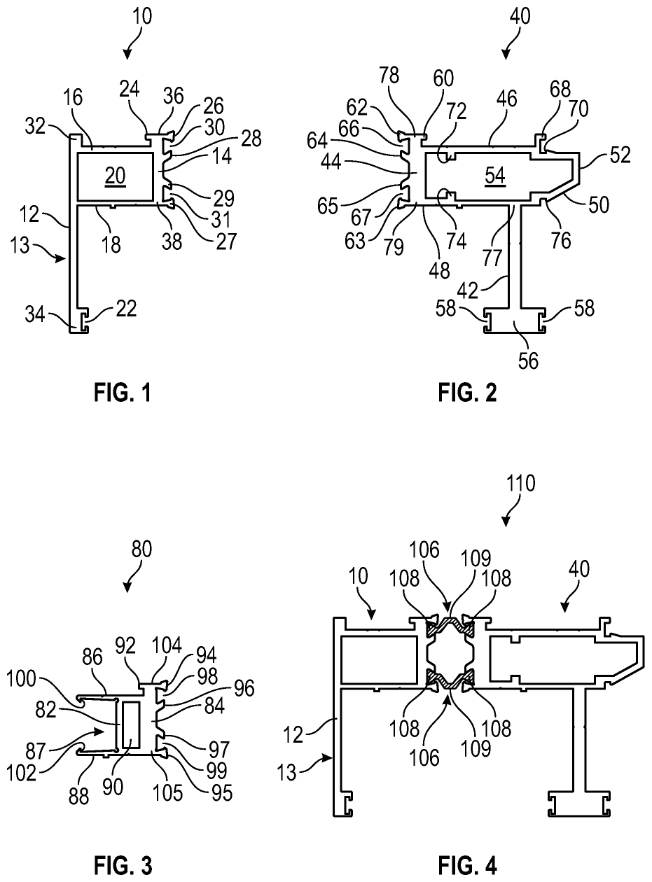

Turning now to the drawings, FIGS. 1-9, together, show various components of an exemplary slidable panel flame assembly 200 (see FIG. 9) in accordance with one aspect of the present disclosure. The slidable panel frame assembly 200 can be positioned overhead in a fenestration such that it forms a head portion (or top horizontal member) of a slidable panel frame, and can be utilized with jamb and sill portions (or side and bottom horizontal members, respectively) and slidable panels to form a slidable panel system. While the slidable panel frame assembly 200 is primarily intended for use with slidable doors and windows, the slidable panel frame assembly 200 can also be utilized with other types of slidable paneling in building fenestration systems. As will be described further herein, the slidable panel frame assembly 200 is assembled from multiple individual components, thereby reducing the constraint inherent in building slidable panel frames having relatively greater depths (compared to traditional sliding door and window systems) to accommodate a plurality of slidable panels, and provides for ease in setup and installation.

Referring first to FIG. 9, an exemplary slidable panel frame assembly 200 (hereinafter frame assembly 200) in accordance with one aspect of the present disclosure is shown. The frame assembly 200 generally comprises a plurality of aluminum profile assemblies 110, 120, and 130, which are coupled together to form a complete, thermally-broken slidable panel frame. The frame assembly 200 can be integrated with other components to form a slidable panel system 300, as seen in FIG. 9. Thus, the slidable panel system 300 can generally include frame assembly 200 and a plurality of slidable panels 310 positioned in the frame assembly 200. As will be appreciated by those of skill in the art, although not depicted in FIG. 9, slidable panel system 300 can include jamb and sill portions (or side and bottom horizontal members, respectively) to form a four-sided frame.

In turn, the aluminum profile assemblies 110, 120, and 130 can each be subdivided into their own principal components. In this regard, and with reference to FIG. 4, aluminum profile assembly 110 generally comprises the following principal components: an end aluminum profile 10, an intermediate aluminum profile 40, and a pair of thermal break strips 106 positioned between the end aluminum profile 10 and intermediate aluminum profile 40.

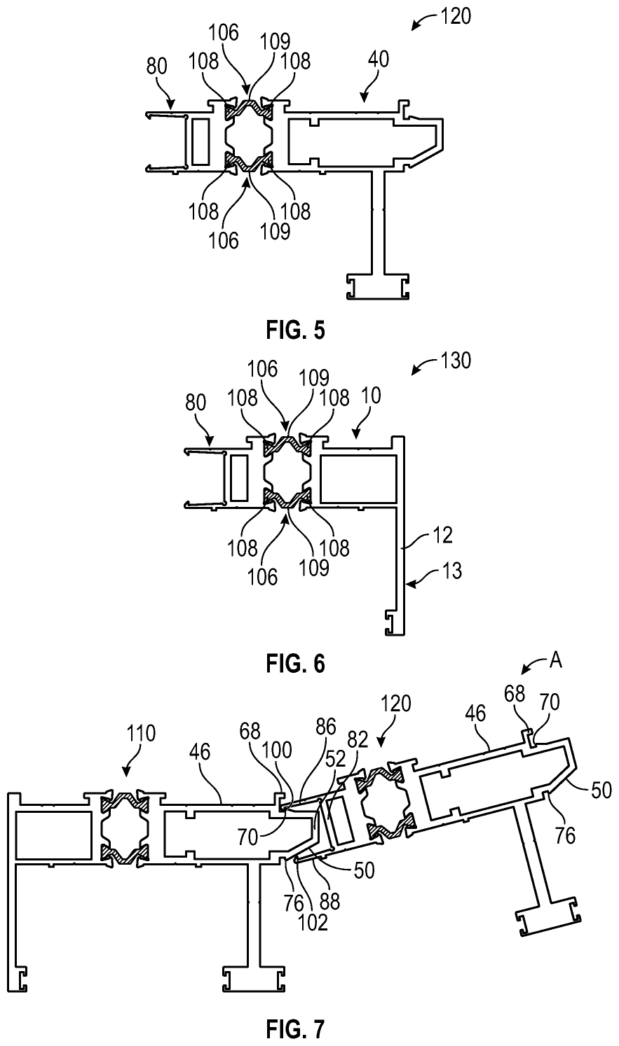

Similarly, and with reference to FIG. 5, aluminum profile assembly 120 generally comprises the following principal components: a connecting aluminum profile 80, an intermediate aluminum profile 40, and a pair of thermal break strips 106 positioned between the connecting aluminum profile 80 and intermediate aluminum profile 40.

Similarly still, and with reference to FIG. 6, aluminum profile assembly 130 generally comprises the following principal components: a connecting aluminum profile 80, an end aluminum profile 10, and a pair of thermal break strips 106 positioned between the connecting aluminum profile 80 and end aluminum profile 10.

The various components of the frame assembly 200 will now be discussed in further detail. Turning first to FIG. 1, particular attention is drawn to the end aluminum profile 10, an end view of which is depicted. As shown in this embodiment, end aluminum profile 10 can generally be substantially P-shaped. End aluminum profile 10 includes a pair of spaced-apart vertical segments 12 and 14, and a pair of spaced-apart horizontal segments 16 and 18 positioned between vertical segment 12 and vertical segment 14. As shown, end aluminum profile 10 is hollow, having a cavity 20 running therethrough. Cavity 20 is defined by vertical segment 12, horizontal segment 16, vertical segment 14, and horizontal segment 18. Each vertical segment 12 and 14 can be positioned perpendicularly relative to each horizontal segment 16 and 18, and vice versa. Thus, with this arrangement of the vertical segments 12 and 14 and horizontal segments 16 and 18, it can be seen that cavity 20 can take on a rectangular shape.

Still referring to FIG. 1, it can be seen that vertical segment 12 extends downwardly from an upper region 32 positioned above horizontal segment 16 to a lower region 34 below horizontal segment 18. Vertical segment 12 can vary in thickness from its upper region 32 to its lower region 34, with a region of vertical segment 12 juxtaposed between the upper region 32 and lower region 34 having a thickness that can be less than a thickness of the upper region 32 and also less than a thickness of the lower region 34. The lower region 34 of vertical segment 12 can have a thickness that is greater than the remainder of vertical segment 12, to accommodate a T-slot 22. T-slot 22 is dimensioned to receive a portion of a brush strip 320 (as seen in FIG. 9) therethrough and to hold the brush strip 320 in position on the frame assembly 200. An outer surface 13 of vertical segment 12 can form a lateral face of an overall frame assembly 200 (as seen in FIG. 9), as discussed further herein.

Referring still to FIG. 1, it can be seen that vertical segment 14 extends upwardly from a lower region 38 proximate horizontal segment 18 to an upper region 36 above horizontal segment 16. The upper region 36 of vertical segment 14 includes a bend 24 extending laterally in the direction of vertical segment 12. Bend 24 can generally help in securing frame assembly 200 in position when installed in a building fenestration. Laterally opposite bend 24 in the upper region 36 of vertical segment 14 is an upper projection 26. Upper projection 26 can be three-sided and substantially triangular in shape. Positioned below upper projection 26 is a first intermediate projection 28. Intermediate projection 28 can be upwardly angled. As seen in this embodiment, upper projection 26 can extend laterally slightly beyond intermediate projection 28, such that upper projection 26 has a length that is slightly greater than a length of intermediate projection 28. Together, upper projection 26 and intermediate projection 28 define an upper slot 30. Continuing along vertical segment 14 in the direction of horizontal segment 18, a second intermediate projection 29 can be seen. Intermediate projection 29 can be downwardly angled. Positioned below intermediate projection 29 is a lower projection 27. Like upper projection 26, lower projection 27 can be three-sided and substantially triangular in shape. Lower projection 27 can extend laterally slightly beyond intermediate projection 29, such that lower projection 27 has a length that is slightly greater than a length of intermediate projection 29. Together, intermediate projection 29 and lower projection 27 define a lower slot 31. As seen in this embodiment, slots 30 and 31 can be of the same dimensions and are preferably mirror images of each other. Slots 30 and 31 are configured to correspond to the shape of end regions 108 of thermal break strips 106, as further described herein. In this way, slots 30 and 31 are each configured to mate with a portion of a thermal break strip 106, as also further described herein.

Turning now to FIG. 2, particular attention is drawn to the intermediate aluminum profile 40, an end view of which is depicted. As shown in this embodiment, intermediate aluminum profile 40 can generally be substantially T-shaped. Intermediate aluminum profile 40 includes a lower vertical segment 42, a pair of spaced-apart upper vertical segments 44 and 52, a pair of spaced-apart horizontal segments 46 and 48, and an angled segment 50 positioned between and joining horizontal segment 48 and upper vertical segment 52. As shown, intermediate aluminum profile 40 is hollow, having a cavity 54 running therethrough. Cavity 54 is generally defined by vertical segment 44, horizontal segment 46, vertical segment 52, angled segment 50, and horizontal segment 48. Vertical segment 44 can be positioned perpendicularly relative to each horizontal segment 46 and 48, and vice versa. Vertical segment 52 can be positioned perpendicularly relative to horizontal segment 46, and vice versa. Angled segment 50 can be positioned in a downwardly angled orientation from vertical segment 52 to horizontal segment 48 (or, put another way, in an upwardly angled orientation from horizontal segment 48 to vertical segment 52). Thus, with this arrangement of the vertical segments 44 and 52, horizontal segments 46 and 48 and angled segment 50, it can be seen that cavity 54 can take on a substantially polygonal shape. Vertical segment 42 can be positioned perpendicularly relative to horizontal segment 48.

Still referring to FIG. 2, it can be seen that vertical segment 42 extends downwardly from an upper region 77 proximate horizontal segment 48 to a lower base region 56. Vertical segment 42 can vary in thickness from its upper region 77 to its base region 56, with a region of vertical segment 42 juxtaposed between the upper region 77 and base region 56 having a thickness that is less than a thickness of the base region 56. The base region 56 of vertical segment 42 can have a thickness that is greater than the remainder of vertical segment 42, to accommodate a pair of T-slots 58. T-slots 58 are each dimensioned to receive a portion of a brush strip 320 (as seen in FIG. 9) therethrough and to hold the brush strip 320 in position on the frame assembly 200.

It should be noted that, as can be seen from a review of FIG. 9, base region 56 of aluminum profile 40 can have a width that is generally greater than the width of lower region 34 of aluminum profile 10. This allows for base region 56 to accommodate two T-slots 58 (whereas lower region 34 has a single T-slot 22). Further, with its greater width (compared to lower region 34), base region 56 is adapted to provide support for two slidable panels 310, with a slidable panel 310 positioned on each side of base region 56.

Referring again to FIG. 2, it can be seen that vertical segment 44 extends upwardly from a lower region 79 proximate horizontal segment 48 to an upper region 78 above horizontal segment 46. The upper region 78 of vertical segment 44 includes a bend 60 extending laterally in the direction of vertical segment 52. Bend 60 can generally help in securing frame assembly 200 in position when installed in a building fenestration. Laterally opposite bend 60 in the upper region 78 of vertical segment 44 is an upper projection 62. Upper projection 62 can be three-sided and substantially triangular in shape. (As can be seen from a review of FIGS. 1 and 2, upper projection 62 is a mirror image of upper projection 26 of end aluminum profile 10.) Positioned below upper projection 62 is a first intermediate projection 64. Intermediate projection 64 can be upwardly angled. (As can be seen from a review of FIGS. 1 and 2, intermediate projection 64 is a mirror image of intermediate projection 28 of end aluminum profile 10.) As seen in this embodiment, upper projection 62 can extend laterally slightly beyond intermediate projection 64, such that upper projection 62 has a length that is slightly greater than a length of intermediate projection 64. Together, upper projection 62 and intermediate projection 64 define an upper slot 66. (As can be seen from a review of FIGS. 1 and 2, upper slot 66 is a mirror image of upper slot 30 of end aluminum profile 10.) Continuing along vertical segment 44 in the direction of horizontal segment 48, a second intermediate projection 65 can be seen. Intermediate projection 65 can be downwardly angled. (As can be seen from a review of FIGS. 1 and 2, intermediate projection 65 is a mirror image of intermediate projection 29 of end aluminum profile 10.) Positioned below intermediate projection 65 is a lower projection 63. Like upper projection 62, lower projection 63 can be three-sided and substantially triangular in shape. Lower projection 63 can extend laterally slightly beyond intermediate projection 65, such that lower projection 63 has a length that is slightly greater than a length of intermediate projection 65. Together, intermediate projection 65 and lower projection 63 define a lower slot 67. (As can be seen from a review of FIGS. 1 and 2, lower slot 67 is a mirror image of lower slot 31 of end aluminum profile 10.) As seen in this embodiment, slots 66 and 67 can be of the same dimensions and are preferably mirror images of each other. Slots 66 and 67 are configured to correspond to the shape of end regions 108 of thermal break strips 106, as further described herein. In this way, slots 66 and 67 are each configured to mate with a portion of a thermal break strip 106, as also further described herein.

Referring still to FIG. 2, extending upwardly from an exterior surface of horizontal segment 46 is a retaining hook 68. Retaining hook 68 can further extend laterally in the direction of vertical segment 52, such that an upper portion of retaining hook 68 is positioned parallel relative to horizontal segment 46, while a lower portion of retaining hook 68 is positioned perpendicular relative to horizontal segment 46. With this configuration, retaining hook 68 can serve as a guide for positioning an upper horizontal segment 86 of aluminum profile 80 when coupling aluminum profile assemblies 110 and 120, as well as when coupling aluminum profile assemblies 120 and 130, as further described herein.

Intermediate aluminum profile 40 can further include one or more receiving members configured to form a snap-fit engagement with one or more coupling members of aluminum profile 80, as further discussed herein. As shown in this embodiment, the one or more receiving members can comprise lips 70 and 76. Thus, positioned below retaining hook 68 is an upper lip 70, which projects substantially vertically from an upper surface of horizontal segment 46. Lip 70 is configured to engage with a hook 100 of connecting aluminum profile 80 when aluminum profile assemblies 110 and 120 are coupled, as well as when aluminum profile assemblies 120 and 130 are coupled, as further described herein. Longitudinally opposite upper lip 70, a lower lip 76 is provided. Lower lip 76 projects substantially vertically from a lower surface of angled segment 50, and is configured to engage with a hook 102 of connecting aluminum profile 80 when aluminum profile assemblies 110 and 120 are coupled, as well as when aluminum profile assemblies 120 and 130 are coupled, as further described herein.

Referring still to FIG. 2, intermediate aluminum profile 40 may further include one or more projections 72 and 74, which project inwardly into cavity 54 from an interior surface of one or both of horizontal segments 46 and 48, respectively, and which can strengthen intermediate aluminum profile 40. While projections 72 and 74 are shown as being substantially square-shaped in this embodiment, projections 72 and 74 can take on other shapes, as may be desired.

Turning now to FIG. 3, particular attention is drawn to the connecting aluminum profile 80, an end view of which is depicted. Connecting aluminum profile 80 includes a pair of spaced-apart vertical segments 82 and 84, and a pair of spaced-apart horizontal segments 86 and 88. As shown, connecting aluminum profile 80 is hollow, having a cavity 90 running therethrough. Cavity 90 is defined by vertical segment 82, horizontal segment 86, vertical segment 84, and horizontal segment 88. Each vertical segment 82 and 84 can be positioned perpendicularly relative to each horizontal segment 86 and 88, and vice versa. Thus, with this arrangement of the vertical segments 82 and 84 and horizontal segments 86 and 88, it can be seen that cavity 90 can take on a rectangular shape.

Still referring to FIG. 3, vertical segments 82 and 84 will be discussed. It can be seen that vertical segment 82 extends between horizontal segment 86 and horizontal segment 88. As shown in this embodiment, vertical segment 82 can have a substantially uniform thickness throughout. Turning to vertical segment 84, it can be seen that vertical segment 84 extends upwardly from a lower region 105 proximate horizontal segment 88 to an upper region 104 above horizontal segment 86. The upper region 104 of vertical segment 84 includes a bend 92 extending laterally in the direction of vertical segment 82. Bend 92 can generally help in securing frame assembly 200 in position when installed in a building fenestration. Laterally opposite bend 92 in the upper region 104 of vertical segment 84 is an upper projection 94. Upper projection 94 can be three-sided and substantially triangular in shape. (As can be seen from a review of FIGS. 2 and 3, upper projection 94 is a mirror image of upper projection 62 of intermediate aluminum profile 40.) Positioned below upper projection 94 is a first intermediate projection 96. Intermediate projection % can be upwardly angled. (As can be seen from a review of FIGS. 2 and 3, intermediate projection % is a mirror image of intermediate projection 64 of intermediate aluminum profile 40.) As seen in this embodiment, upper projection 94 can extend laterally slightly beyond intermediate projection %, such that upper projection 94 has a length that is slightly greater than a length of intermediate projection %. Together, upper projection 94 and intermediate projection 96 define an upper slot 98. (As can be seen from a review of FIGS. 2 and 3, upper slot 98 is a mirror image of upper slot 66 of intermediate aluminum profile 40.) Continuing along vertical segment 84 in the direction of horizontal segment 88, a second intermediate projection 97 can be seen. Intermediate projection 97 can be downwardly angled. (As can be seen from a review of FIGS. 2 and 3, intermediate projection 97 is a mirror image of intermediate projection 65 of intermediate aluminum profile 40.) Positioned below intermediate projection 97 is a lower projection 95. Like upper projection 94, lower projection 95 can be three-sided and substantially triangular in shape. Lower projection 95 can extend laterally slightly beyond intermediate projection 97, such that lower projection 95 has a length that is slightly greater than a length of intermediate projection 97. Together, intermediate projection 97 and lower projection 95 define a lower slot 99. (As can be seen from a review of FIGS. 2 and 3, lower slot 99 is a mirror image of lower slot 67 of intermediate aluminum profile 40.) As seen in this embodiment, slots 98 and 99 can be of the same dimensions and are preferably mirror images of each other. Slots 98 and 99 are configured to correspond to the shape of end regions 108 of thermal break strips 106, as further described herein. In this way, slots 98 and 99 are each configured to mate with a portion of a thermal break strip 106, as also further described herein.

Referring still to FIG. 3, it can be seen that horizontal segments 86 and 88 each extend laterally in a direction away from vertical segment 82, defining a channel 87. Channel 87 is configured to receive a portion of intermediate aluminum profile 40 therein when aluminum profile assemblies 110 and 120 are coupled, as well as when aluminum profile assemblies 120 and 130 are coupled, as further described herein.

Connecting aluminum profile 80 can further include one or more coupling members configured to form a snap-fit engagement with the one or more receiving members of intermediate aluminum profile 40, as further discussed herein. As shown in this embodiment, the one or more coupling members can comprise hooks 100 and 102. Thus, positioned on an end of horizontal segment 86 is an upper hook 100, which projects substantially vertically from a lower surface of horizontal segment 86 in the direction of channel 87. Hook 100 is configured to engage with lip 70 of intermediate aluminum profile 40 when aluminum profile assemblies 110 and 120 are coupled, as well as when aluminum assemblies 120 and 130 are coupled, as further described herein. Longitudinally opposite hook 100, a lower hook 102 is provided. Hook 102 projects substantially vertically from an upper surface of horizontal segment 88 in the direction of channel 87. Hook 102 is configured to engage with lip 76 of intermediate aluminum profile 40 when aluminum profile assemblies 110 and 120 are coupled, as well as when aluminum profile assemblies 120 and 130 are coupled, as further described herein.

As will be appreciated by those of skill in the art, aluminum profiles 10, 40, and 80 are elongated. Aluminum profiles 10, 40, and 80 can be configured of various lengths to correspond to the dimensions of various fenestrations into which the frame assembly 200 may be installed. Aluminum profiles 10, 40, and 80 can be formed by an extrusion process known to those of skill in the art.

The aluminum profile assemblies 110, 120, and 130 will now be discussed in further detail. Turning to FIG. 4, particular attention is drawn to aluminum profile assembly 110. As seen in this embodiment and, as previously noted, aluminum profile assembly 110 comprises end aluminum profile 10, intermediate aluminum profile 40, and a pair of thermal break strips 106 positioned between the end aluminum profile 10 and intermediate aluminum profile 40. (End aluminum profile 10 is oriented such that outer surface 13 of vertical segment 12 forms a lateral face of the overall frame assembly 200, as seen in FIG. 9.) As seen in this embodiment, thermal break strips 106 include end regions 108, which are configured to be positioned in and mate with slots 30, 31 (see FIG. 1), 66, and 67 (see FIG. 2) of aluminum profiles 10 and 40, respectively. Further, thermal break strips 106 include middle regions 109. Middle regions 109 can be generally substantially U-shaped. A first, upper thermal break strip 106 can be positioned such that the “U” is inverted, while a second, lower thermal break strip 106 can be positioned such that the “U” is upright. Each end region 108 can be substantially three-sided, to correspond to the shape of slots 30, 31, 66, and 67. Aluminum profile assembly 110 can be assembled by positioning end regions 108 of an upper thermal break strip 106 in slot 30 of aluminum profile 10 and slot 66 of aluminum profile 40, respectively, and end regions 108 of a lower thermal break strip 106 in slots 31 of aluminum profile 10 and slot 67 of aluminum profile 40, respectively. After end regions 108 are positioned in their respective slots, the thermal break strips 106 can be secured in place by crimping upper projection 26 and intermediate projection 28 of aluminum profile 10 and crimping upper projection 62 and intermediate projection 64 of aluminum profile 40 to secure an upper thermal break strip 106 in position, and by crimping lower projection 27 and intermediate projection 29 of aluminum profile 10 and crimping lower projection 63 and intermediate projection 65 of aluminum profile 40 to secure a lower thermal break strip 106 in position. In this way, aluminum profiles 10 and 40 can be securely coupled to form aluminum profile assembly 110.

Turning now to FIG. 5, particular attention is drawn to aluminum profile assembly 120. As seen in this embodiment and, as previously noted, aluminum profile assembly 120 comprises connecting aluminum profile 80, intermediate aluminum profile 40, and a pair of thermal break strips 106 positioned between the connecting aluminum profile 80 and intermediate aluminum profile 40. As previously noted, middle regions 109 of thermal break strips 106 can be generally substantially U-shaped. Similar to the positioning of thermal break strips 106 in aluminum profile assembly 110, end regions 108 of thermal break strips 106 are also are configured to be positioned in and mate with slots 98 and 99 (see FIG. 3) of aluminum profile 80. Thus, each end region 108 can be substantially three-sided, to correspond to the shape of slots 98 and 99, as well. As with aluminum profile assembly 110, with aluminum profile assembly 120, a first, upper thermal break strip 106 can be positioned such that the “U” of middle region 109 is inverted, while a second, lower thermal break strip 106 can be positioned such that the “U” of middle region 109 is upright. Similar to aluminum profile assembly 110, aluminum profile assembly 120 can be assembled by positioning end regions 108 of an upper thermal break strip 106 in slot 98 of aluminum profile 80 and slot 66 of aluminum profile 40, respectively, and end regions 108 of a lower thermal break strip 106 in slots 99 of aluminum profile 80 and slot 67 of aluminum profile 40, respectively. After end regions 108 are positioned in their respective slots, the thermal break strips 106 can be secured in place by crimping upper projection 94 and intermediate projection 96 of aluminum profile 80 and crimping upper projection 62 and intermediate projection 64 of aluminum profile 40 to secure an upper thermal break strip 106 in position, and by crimping lower projection 95 and intermediate projection 97 of aluminum profile 80 and crimping lower projection 63 and intermediate projection 65 of aluminum profile 40 to secure a lower thermal break strip 106 in position. In this way, aluminum profiles 80 and 40 can be securely coupled to form aluminum profile assembly 120.

Turning now to FIG. 6, particular attention is drawn to aluminum profile assembly 130. As seen in this embodiment and, as previously noted, aluminum profile assembly 130 comprises connecting aluminum profile 80, end aluminum profile 10, and a pair of thermal break strips 106 positioned between the connecting aluminum profile 80 and end aluminum profile 10. (It should be noted that in aluminum profile assembly 130, end aluminum profile 10 is shown inverted compared to the positioning of end aluminum profile 10 in aluminum profile assembly 110, such that outer surface 13 of vertical segment 12 forms a lateral face of the overall frame assembly 200, as seen in FIG. 9.) As previously noted, middle regions 109 of thermal break strips 106 can be generally substantially U-shaped. As with the positioning of thermal break strips 106 in aluminum profile assemblies 110 and 120, end regions 108 of thermal break strips 106 are configured to be positioned in and mate with slots 98 and 99 (see FIG. 3) of aluminum profile 80 and slots 30 and 31 (see FIG. 1) of aluminum profile 10. As with aluminum profile assemblies 110 and 120, with aluminum profile assembly 130, a first, upper thermal break strip 106 can be positioned such that the “U” of middle region 109 is inverted, while a second, lower thermal break strip 106 can be positioned such that the “U” of middle region 109 is upright. Similar to aluminum profile assemblies 110 and 120, aluminum profile assembly 130 can be assembled by positioning end regions 108 of an upper thermal break strip 106 in slot 98 of aluminum profile 80 and slot 30 of aluminum profile 10, respectively, and end regions 108 of a lower thermal break strip 106 in slot 99 of aluminum profile 80 and slot 31 of aluminum profile 10, respectively. After end regions 108 are positioned in their respective slots, the thermal break strips 106 can be secured in place by crimping upper projection 94 and intermediate projection 96 of aluminum profile 80 and crimping upper projection 26 and intermediate projection 28 of aluminum profile 10 to secure an upper thermal break strip 106 in position, and by crimping lower projection 95 and intermediate projection 97 of aluminum profile 80 and crimping lower projection 27 and intermediate projection 29 of aluminum profile 10 to secure a lower thermal break strip 106 in position. In this way, aluminum profiles 80 and 10 can be securely coupled to form aluminum profile assembly 130.

As will be appreciated by those of skill in the art, the thermal break strips 106 described above can be comprised of an insulating material suitable for resisting thermal conductivity in door and window systems. As such, the thermal break strips 106 help to provide improved energy efficiency. As will be appreciated by those of skill in the art, thermal break strips 106 are elongated. Preferably, thermal break strips 106 are configured with lengths corresponding to the lengths of the various aluminum profiles 10, 40, and 80 with which they mate. Thermal break strips 106 can be configured of various lengths to correspond to the dimensions of various fenestrations into which the frame assembly 200 may be installed. Thermal break strips 106 can be formed by an extrusion process or other suitable processes known to those of skill in the art.

Turning now to FIGS. 7-9, construction of the frame assembly 200 will be discussed in further detail. Once the aluminum profile assemblies 110, 120, and 130 have been assembled, the aluminum profile assemblies 110, 120, and 130 can then be coupled to form a fully assembled, thermally-broken sliding panel frame assembly 200 that supports slidable panels. In this regard and, with reference to FIG. 7, coupling of aluminum profile assemblies 110 and 120 is depicted. As shown in this embodiment, aluminum profile assembly 120 can be snap fitted onto aluminum profile assembly 110, forming a first assembly A. In order to couple aluminum profile assemblies 110 and 120 in this manner, a user (or users) would position aluminum profile assembly 120 on a slight upward angle relative to aluminum profile assembly 110, orienting lower horizontal segment 88 proximate angled segment 50 and upper horizontal segment 86 proximate horizontal segment 46. The user would then direct upper horizontal segment 86 toward retaining hook 68, with horizontal segment 86 oriented below an upper portion of retaining hook 68, so that hook 100 engages lip 70. (It should be noted that, in this way, retaining hook 68 helps guide placement of upper horizontal segment 86.) The user would then snap fit aluminum profile assembly 120 into position on aluminum profile assembly 110 by lowering aluminum profile assembly 120 until hook 102 engages lip 76 and aluminum profile assembly 120 snaps into place. Once coupled, aluminum profile assemblies 110 and 120 are positioned side by side, with vertical segment 52 contacting vertical segment 82, as can be seen in FIG. 9.

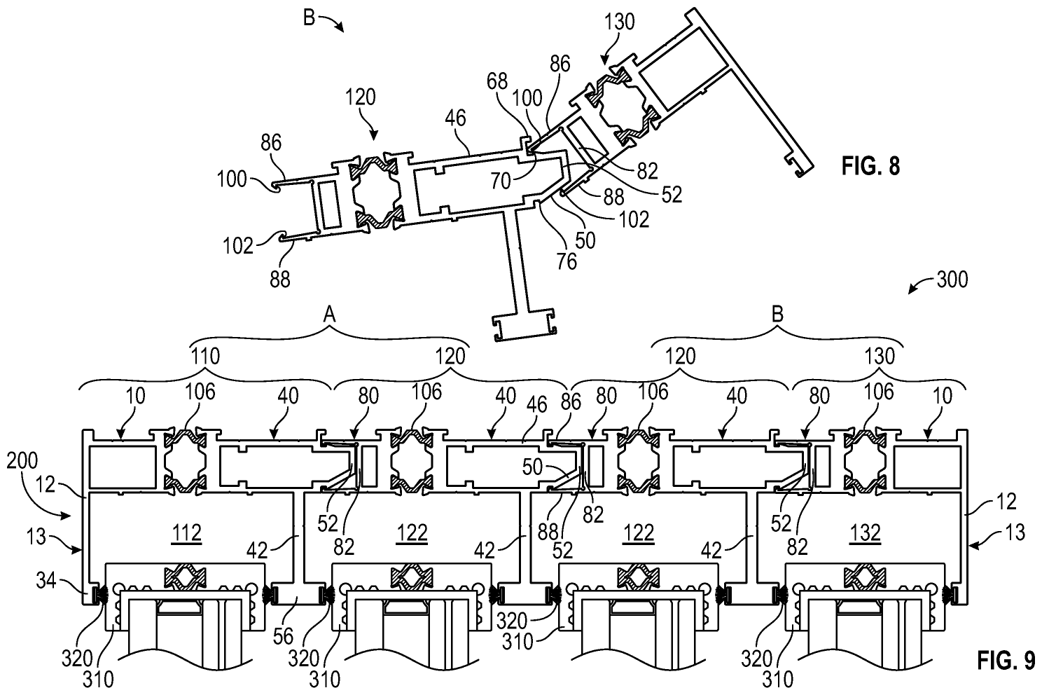

Next, and with reference to FIG. 8, coupling of aluminum profile assemblies 120 and 130 is depicted. As shown in this embodiment, aluminum profile assembly 120 can be snap fitted onto aluminum profile assembly 130, forming a second assembly B. As with the coupling of aluminum profile assemblies 110 and 120, in order to couple aluminum profile assemblies 120 and 130 in this manner, a user would position aluminum profile assembly 130 on a slight upward angle relative to aluminum profile assembly 120, orienting lower horizontal segment 88 proximate angled segment 50 and upper horizontal segment 86 proximate horizontal segment 46. The user would then direct upper horizontal segment 86 toward retaining hook 68, with horizontal segment 86 oriented below an upper portion of retaining hook 68, so that hook 100 engages lip 70. The user would then snap fit aluminum profile assembly 130 into position on aluminum profile assembly 120 by lowering aluminum profile assembly 130 until hook 102 engages lip 76 and aluminum profile assembly 130 snaps into place. Once coupled, aluminum profile assemblies 120 and 130 are positioned side by side, with vertical segment 52 contacting vertical segment 82, as can be seen in FIG. 9.

Turning now to FIG. 9, once aluminum profile assemblies 110 and 120 have been coupled to form assembly A and aluminum profile assemblies 120 and 130 have been coupled to form assembly B, assemblies A and B can, in turn, be coupled to form frame assembly 200. The coupling of assemblies A and B is similar to the coupling of aluminum profile assemblies 110 and 120 to form assembly A and the coupling of aluminum profiles 120 and 130 to form assembly B. In this regard, in order to couple assemblies A and B in this manner, a user would position assembly B on a slight upward angle relative to assembly A, orienting lower horizontal segment 88 (of aluminum profile assembly 120 of assembly B) (see FIG. 8) proximate angled segment 50 (of aluminum profile assembly 120 of assembly A) (see FIG. 7) and upper horizontal segment 86 (of aluminum profile assembly 120 of assembly B) (see FIG. 8) proximate horizontal segment 46 (of aluminum profile assembly 120 of assembly A) (see FIG. 7). The user would then direct upper horizontal segment 86 (of aluminum profile assembly 120 of assembly B) (see FIG. 8) toward retaining hook 68 (of aluminum profile assembly 120 of assembly A) (see FIG. 7), with upper horizontal segment 86 (of aluminum profile assembly 120 of assembly B) (see FIG. 8) oriented below an upper portion of retaining hook 68 (of aluminum profile assembly 120 of assembly A) (see FIG. 7), so that hook 100 (of aluminum profile assembly 120 of assembly B) (see FIG. 8) engages lip 70 (of aluminum profile assembly 120 of assembly A) (see FIG. 7). The user would then snap fit assembly B into position on assembly A by lowering assembly B until hook 102 (of aluminum profile assembly 120 of assembly B) (see FIG. 8) engages lip 76 (of aluminum profile assembly 120 of assembly A) (see FIG. 7) and assembly B snaps into place. Once coupled, assemblies A and B are positioned side by side, forming frame assembly 200, as can be seen in FIG. 9. From the foregoing, it can be appreciated that a very simple and practical way to assemble different aluminum profiles into a complete, thermally-broken frame assembly has been provided.

An advantage of forming the frame assembly 200 from multiple individual components that are coupled in the manner described herein is that the individual components can be separately extruded, as opposed to forming an entire frame assembly as a one-piece component which can be cumbersome to manufacture, as well as to transport and maneuver. Further, the individual components can be brought to the installation site and assembled to form the frame assembly 200 on-site. Further still, the snap-fit configuration of the frame assembly 200 allows for ease in setting up frame assemblies 200 having enlarged depths. Compared to known frame assemblies, this reduces the constraint inherent in building slidable panel frames having relatively greater dimensions that are necessary to accommodate multiple slidable panels used in modern construction, and provides for ease in setup and installation. Further, such a configuration can be easily adapted to accommodate various dimensions of building fenestrations, by adding or omitting one or more profile assemblies 120 in the frame assembly 200, as discussed above.

Referring to FIG. 9 and, as previously discussed, frame assembly 200 generally comprises a plurality of aluminum profile assemblies 110, 120, and 130, which are coupled together to form a complete, thermally-broken slidable panel frame. Frame assembly 200 includes a plurality of channels 112, 122, and 132 defined by adjacent aluminum profile assemblies 110, 120, and 130, respectively. Each channel 112, 122, and 132 is configured to receive a portion of a slidable panel or panels therein. While frame assembly 200 is shown as having one channel 112, two channels 122, and one channel 132 for a total of four channels, it should be understood that frame assembly 200 could be configured with more than four or fewer than four channels, as may be desired, depending upon the number of slidable panels utilized with a given frame assembly 200. For example, if a frame assembly 200 to support three slidable panels is desired, with each channel receiving a single slidable panel, a user could omit one of the two aluminum profile assemblies 120 (which, in turn, would eliminate one channel 122). As another example, if a frame assembly 200 to support five slidable panels is desired, with each channel receiving a single slidable panel, a user could add a third aluminum profile assembly 120 between aluminum profile assemblies 110 and 130 (which, in turn, would add a channel 122), following the procedure for coupling an aluminum profile assembly 120 to an adjacent aluminum profile assembly 110 or 120, as discussed above.

As previously noted, frame assembly 200 can be installed overhead in a fenestration such that it forms a head portion (or top horizontal member) of a slidable panel frame. For example, a top horizontal portion of a rough opening can provide a proper surface for installing the frame assembly 200. The frame assembly 200 can be utilized in conjunction with jamb and sill portions (or side and bottom horizontal members, respectively) and slidable panels to form a slidable panel system. The frame assembly 200 can be installed in a rough opening using methods known to those skilled in the relevant art.

Referring still to FIG. 9 and, as previously noted, frame assembly 200 can be integrated with other components to form a slidable panel system 300. As shown in FIG. 9, the slidable panel system 300 generally comprises frame assembly 200 and a plurality of slidable panels 310 positioned in the frame assembly 200, wherein each slidable panel 310 is positioned in one of a plurality of channels 112, 122, and 132. Various components of the frame assembly 200 can engage the slidable panels 310. In this regard, vertical segment 12 and lower vertical segment 42 flanking channel 112 can engage a first slidable panel 310, lower vertical segments 42 flanking channels 122 can engage second and third slidable panels 310, and lower vertical segment 42 and vertical segment 12 flanking channel 132 can engage a fourth slidable panel 310. In this embodiment, four slidable panels 310 are utilized. However, as previously noted, it should be understood that the frame assembly 200 of the slidable panel system 300 may be configured to accommodate more than four or fewer than four slidable panels 310, as may be desired. The slidable panels 310 can include windows, doors, etc. While the slidable panels 310 shown are straight, the slidable panels 310 can contain curves and the slidable panel system 300 can be modified for the curved slidable panels 310. The slidable panels 310 of the slidable panel system 300 described above can be in a closed or opened position. In the opened position, the slidable panels 310 can be placed on one side of the fenestration, on both sides of the fenestration, or in wall pockets on either or both sides of the fenestration, depending upon the particular configurations of the building structure where the slidable panel system 300 is installed. The slidable panels 310 can be extended from their opened position along their respective channels 112, 122, and 132 into a closed position. In one embodiment, when the slidable panels 310 are in the closed position, the slidable panels 310 can be positioned end-to-end, in an interlocking arrangement with one another.

In one embodiment, slidable panel system 300 can further include a plurality of brush strips 320, wherein one brush strip 320 is positioned in each of T-slots 22 and 58. Thus, it can be seen that each slidable panel 310 can be positioned between a pair of opposing brush strips 320. While in this embodiment a total of eight brush strips 320 are illustrated, it should be understood that more than eight or fewer than eight brush strips 320 may be utilized, depending upon the number of slidable panels 310 utilized in the slidable panel system 300.

The foregoing description is illustrative of particular embodiments of the invention, but is not meant to be a limitation upon the practice thereof. While embodiments of the disclosure have been described in terms of various specific embodiments, those skilled in the art will recognize that the embodiments of the disclosure may be practiced with modifications without departing from the spirit and scope of the invention. By way of example only, while the foregoing description provides various components for the frame assembly 200, as will be appreciated by those of skill in the art, fewer or more components can be incorporated into the frame assembly 200. As a further example, although various components of the frame assembly 200 are described as being made of aluminum, as will be appreciated by those of skill in the art, it would be possible to utilize other suitable materials for the frame assembly 200, without departing from the spirit and scope of the invention.

What is claimed is:

1. A slidable panel frame assembly comprising, in combination:
a plurality of aluminum profile assemblies, including at least a first aluminum profile assembly and a second aluminum profile assembly;
wherein the first aluminum profile assembly comprises:
an end aluminum profile;
an intermediate aluminum profile spaced apart from the end aluminum profile, wherein the intermediate aluminum profile has first and second receiving members; and
at least one thermal break strip juxtaposed between the end aluminum profile and the intermediate aluminum profile, wherein the at least one thermal break strip is configured to be coupled to the end aluminum profile and the intermediate aluminum profile so that the end aluminum profile and the intermediate aluminum profile can be coupled together;
wherein the second aluminum profile assembly comprises:
a connecting aluminum profile, wherein the connecting aluminum profile has first and second coupling members;
an end aluminum profile spaced apart from the connecting aluminum profile; and
at least one thermal break strip juxtaposed between the connecting aluminum profile and the end aluminum profile, wherein the at least one thermal break strip is configured to be coupled to the connecting aluminum profile and the end aluminum profile so that the connecting aluminum profile and the end aluminum profile can be coupled together;
wherein the first and second coupling members of the second aluminum profile assembly are configured to form a snap-fit engagement with the first and second receiving members of the first aluminum profile assembly so that the plurality of aluminum profile assemblies can be coupled together; and
a plurality of channels defined by the plurality of aluminum profile assemblies, wherein each channel is configured to receive a portion of at least one slidable panel.

2. The slidable panel frame assembly of claim 1, further comprising a third aluminum profile assembly, wherein the third aluminum profile assembly comprises:
a connecting aluminum profile, wherein the connecting aluminum profile has first and second coupling members;
an intermediate aluminum profile spaced apart from the connecting aluminum profile, wherein the intermediate aluminum profile has first and second receiving members; and
at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together;
wherein the first and second coupling members of the third aluminum profile assembly are configured to form a snap-fit engagement with the first and second receiving members of the first aluminum profile assembly; and
wherein the first and second coupling members of the second aluminum profile assembly are configured to form a snap-fit engagement with the first and second receiving members of the third aluminum profile assembly so that the plurality of aluminum profile assemblies can be coupled together.

3. The slidable panel frame assembly of claim 2, further comprising a fourth aluminum profile assembly, wherein the fourth aluminum profile assembly comprises:
a connecting aluminum profile, wherein the connecting aluminum profile has first and second coupling members;
an intermediate aluminum profile spaced apart from the connecting aluminum profile, wherein the intermediate aluminum profile has first and second receiving members; and
at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together;
wherein the first and second coupling members of the fourth aluminum profile assembly are configured to form a snap-fit engagement with the first and second receiving members of the third aluminum profile assembly, and
wherein the first and second coupling members of the second aluminum profile assembly are configured to form a snap-fit engagement with the first and second receiving members of the fourth aluminum profile assembly so that the plurality of aluminum profile assemblies can be coupled together.

4. The slidable panel frame assembly of claim 1, wherein the first aluminum profile assembly and the second aluminum profile assembly each further comprise two thermal break strips.

5. The slidable panel frame assembly of claim 2, wherein the third aluminum profile assembly further comprises two thermal break strips.

6. The slidable panel frame assembly of claim 3, wherein the fourth aluminum profile assembly further comprises two thermal break strips.

7. The slidable panel frame assembly of claim 1, wherein the end aluminum profiles of the first and second aluminum profile assemblies further comprise:
a pair of spaced-apart vertical segments including a first vertical segment and a second vertical segment; and
a pair of spaced-apart horizontal segments;
wherein the first vertical segment includes a T-slot; and
wherein the second vertical segment includes an upper slot and a lower slot, wherein the upper slot and the lower slot are each configured to mate with a portion of the at least one thermal break strip.

8. The slidable panel frame assembly of claim 1, wherein the intermediate aluminum profile further comprises:
a lower vertical segment;
a pair of spaced-apart upper vertical segments including a first upper vertical segment and a second upper vertical segment;
a pair of spaced-apart horizontal segments; and
an angled segment;
wherein the lower vertical segment includes at least one T-slot; and
wherein the first upper vertical segment includes an upper slot and a lower slot, wherein the upper slot and the lower slot are each configured to mate with a portion of the at least one thermal break strip.

9. The slidable panel frame assembly of claim 1, wherein the connecting aluminum profile further comprises:
a pair of spaced-apart vertical segments including a first vertical segment and a second vertical segment; and
a pair of spaced-apart horizontal segments;
wherein the second vertical segment includes an upper slot and a lower slot, wherein the upper slot and the lower slot are each configured to mate with a portion of the at least one thermal break strip.

10. The slidable panel frame assembly of claim 1, wherein the first and second receiving members of the intermediate aluminum profile each comprise a lip.

11. The slidable panel frame assembly of claim 10, wherein the first and second coupling members of the connecting aluminum profile each comprise a hook.

12. A slidable panel frame assembly comprising, in combination:
a plurality of aluminum profile assemblies, including at least a first aluminum profile assembly, a second aluminum profile assembly, a third aluminum profile assembly, and a fourth aluminum profile assembly;
wherein the first aluminum profile assembly comprises:
an end aluminum profile;
an intermediate aluminum profile spaced apart from the end aluminum profile, wherein the intermediate aluminum profile has first and second receiving members; and
at least one thermal break strip juxtaposed between the end aluminum profile and the intermediate aluminum profile, wherein the at least one thermal break strip is configured to be coupled to the end aluminum profile and the intermediate aluminum profile so that the end aluminum profile and the intermediate aluminum profile can be coupled together;
wherein the second aluminum profile assembly comprises:
a connecting aluminum profile, wherein the connecting aluminum profile has first and second coupling members;
an end aluminum profile spaced apart from the connecting aluminum profile; and
at least one thermal break strip juxtaposed between the connecting aluminum profile and the end aluminum profile, wherein the at least one thermal break strip is configured to be coupled to the connecting aluminum profile and the end aluminum profile so that the connecting aluminum profile and the end aluminum profile can be coupled together;
wherein the third aluminum profile assembly comprises:
a connecting aluminum profile, wherein the connecting aluminum profile has first and second coupling members;
an intermediate aluminum profile spaced apart from the connecting aluminum profile, wherein the intermediate aluminum profile has first and second receiving members; and
at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together; and
wherein the fourth aluminum profile assembly comprises:
a connecting aluminum profile, wherein the connecting aluminum profile has first and second coupling members;
an intermediate aluminum profile spaced apart from the connecting aluminum profile, wherein the intermediate aluminum profile has first and second receiving members; and
at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together;
wherein the first and second coupling members of the third aluminum profile assembly are configured to form a snap-fit engagement with the first and second receiving members of the first aluminum profile assembly; and
wherein the first and second coupling members of the fourth aluminum profile assembly are configured to form a snap-fit engagement with the first and second receiving members of the third aluminum profile assembly; and
wherein the first and second coupling members of the second aluminum profile assembly are configured to form a snap-fit engagement with the first and second receiving members of the fourth aluminum profile assembly so that the plurality of aluminum profile assemblies can be coupled together; and
a plurality of channels defined by the plurality of aluminum profile assemblies, wherein each channel is configured to receive a portion of at least one slidable panel.

13. The slidable panel frame assembly of claim 12, wherein the first aluminum profile assembly, the second aluminum profile assembly, the third aluminum profile assembly, and the fourth aluminum profile assembly each further comprise two thermal break strips.

14. The slidable panel frame assembly of claim 12, wherein the end aluminum profiles of the first and second aluminum profile assemblies further comprise:
a pair of spaced-apart vertical segments including a first vertical segment and a second vertical segment; and
a pair of spaced-apart horizontal segments;
wherein the first vertical segment includes a T-slot; and
wherein the second vertical segment includes an upper slot and a lower slot, wherein the upper slot and the lower slot are each configured to mate with a portion of the at least one thermal break strip.

15. The slidable panel frame assembly of claim 12, wherein the intermediate aluminum profiles of the first, third, and fourth aluminum profile assemblies further comprise:
a lower vertical segment;
a pair of spaced-apart upper vertical segments including a first upper vertical segment and a second upper vertical segment;
a pair of spaced-apart horizontal segments; and
an angled segment;
wherein the lower vertical segment includes at least one T-slot; and
wherein the first upper vertical segment includes an upper slot and a lower slot, wherein the upper slot and the lower slot are each configured to mate with a portion of the at least one thermal break strip.

16. The slidable panel frame assembly of claim 12, wherein the connecting aluminum profiles of the second, third, and fourth aluminum profile assemblies further comprise:
a pair of spaced-apart vertical segments including a first vertical segment and a second vertical segment; and
a pair of spaced-apart horizontal segments;
wherein the second vertical segment includes an upper slot and a lower slot, wherein the upper slot and the lower slot are each configured to mate with a portion of the at least one thermal break strip.

17. The slidable panel frame assembly of claim 12, wherein the first and second receiving members of the intermediate aluminum profiles of the first, third, and fourth aluminum profile assemblies each comprise a lip.

18. The slidable panel frame assembly of claim 17, wherein the first and second coupling members of the connecting aluminum profiles of the second, third, and fourth aluminum profile assemblies each comprise a hook.

19. A slidable panel system comprising, in combination:
a plurality of slidable panels;
a plurality of aluminum profile assemblies, including at least a first aluminum profile assembly, a second aluminum profile assembly, a third aluminum profile assembly, and a fourth aluminum profile assembly;
wherein the first aluminum profile assembly comprises:
an end aluminum profile;
an intermediate aluminum profile spaced apart from the end aluminum profile, wherein the intermediate aluminum profile has first and second receiving members; and
at least one thermal break strip juxtaposed between the end aluminum profile and the intermediate aluminum profile, wherein the at least one thermal break strip is configured to be coupled to the end aluminum profile and the intermediate aluminum profile so that the end aluminum profile and the intermediate aluminum profile can be coupled together;
wherein the second aluminum profile assembly comprises:
a connecting aluminum profile, wherein the connecting aluminum profile has first and second coupling members;
an end aluminum profile spaced apart from the connecting aluminum profile; and
at least thermal break strip juxtaposed between the connecting aluminum profile and the end aluminum profile, wherein the at least one thermal break strip is configured to be coupled to the connecting aluminum profile and the end aluminum profile so that the connecting aluminum profile and the end aluminum profile can be coupled together;
wherein the third aluminum profile assembly comprises:
a connecting aluminum profile, wherein the connecting aluminum profile has first and second coupling members;
an intermediate aluminum profile spaced apart from the connecting aluminum profile, wherein the intermediate aluminum profile has first and second receiving members; and
at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together, and
wherein the fourth aluminum profile assembly comprises:
a connecting aluminum profile, wherein the connecting aluminum profile has first and second coupling members;
an intermediate aluminum profile spaced apart from the connecting aluminum profile, wherein the intermediate aluminum profile has first and second receiving members; and
at least one thermal break strip juxtaposed between the connecting aluminum profile and the intermediate aluminum profile, wherein the at least one thermal break strip is configured to be coupled to the connecting aluminum profile and the intermediate aluminum profile so that the connecting aluminum profile and intermediate aluminum profile can be coupled together;
wherein the first and second coupling members of the third aluminum profile assembly are configured to form a snap-fit engagement with the first and second receiving members of the first aluminum profile assembly; and
wherein the first and second coupling members of the fourth aluminum profile assembly are configured to form a snap-fit engagement with the first and second receiving members of the third aluminum profile assembly; and
wherein the first and second coupling members of the second aluminum profile assembly are configured to form a snap-fit engagement with the first and second receiving members of the fourth aluminum profile assembly so that the plurality of aluminum profile assemblies can be coupled together; and
a plurality of channels defined by the plurality of aluminum profile assemblies, wherein each channel is configured to receive a portion of at least one of the plurality of slidable panels.

20. The slidable panel system of claim 19, wherein the first aluminum profile assembly, the second aluminum profile assembly, the third aluminum profile assembly, and the fourth aluminum profile assembly each further comprise:
at least one brush strip; and
at least one T-slot, wherein each T-slot is configured to receive at least a portion of one of the at least one brush strip.
